(19) United States
(12) Patent Application Publication
(10) Pub. No.: US 2003/0213883 A1
(43) Pub. Date: Nov. 20, 2003

(54) Ceiling fan mounting ball

(75) Inventor: Chang Fu-Liang, Feng Yuan City (TW)

Correspondence Address: HAYNES AND BOONE, LLP, 901 MAIN STREET, SUITE 3100, DALLAS, TX, 75202, US

(73) Assignee: Craftmade International, Inc., Coppell, TX

(21) Appl. No.: 10/342,425

(22) Filed: Jan. 14, 2003

(30) Foreign Application Priority Data
May 15, 2002 (TW) 91206936

(51) Int. Cl. B42F 13/00; F03D 11/00

(52) U.S. Cl. 248/343; 416/5

(57) ABSTRACT

A fan ball for mounting a ceiling fan is described, wherein the fan ball has damping means for preventing the fan ball from mechanically transferring any appreciable degree of vibration to the fan, thereby preventing undesirable noise.

### BACKGROUND

The present disclosure relates generally to a ceiling fan mounting ball (hereinafter “fan ball”). Fan balls provide the ball portion of a ball and socket type interaction, thereby allowing a ceiling fan to hang straight even when mounted on a variety of sloped surfaces.

In the past, fan balls mechanically transferred an appreciable degree of vibration from the fan's environment to the fan, thereby causing undesirable noise.

Therefore, what is needed is a fan ball having dampening means to prevent vibration.

### BRIEF DESCRIPTION OF THE DRAWINGS

FIG. 1 is a perspective view of a fan ball according to one embodiment of the present invention.

FIG. 2 is a top plan view of the fan ball.

FIG. 3 is a cross-sectional view of the fan ball taken along the line 3-3 in FIG. 2.

FIG. 4 is an exploded view of the fan ball.

FIG. 5 is a partial sectional bottom view of an alternative embodiment of a fan ball.

FIG. 6 is a perspective view of a fan ball with several conventional mounting components illustrated in phantom.

### DESCRIPTION

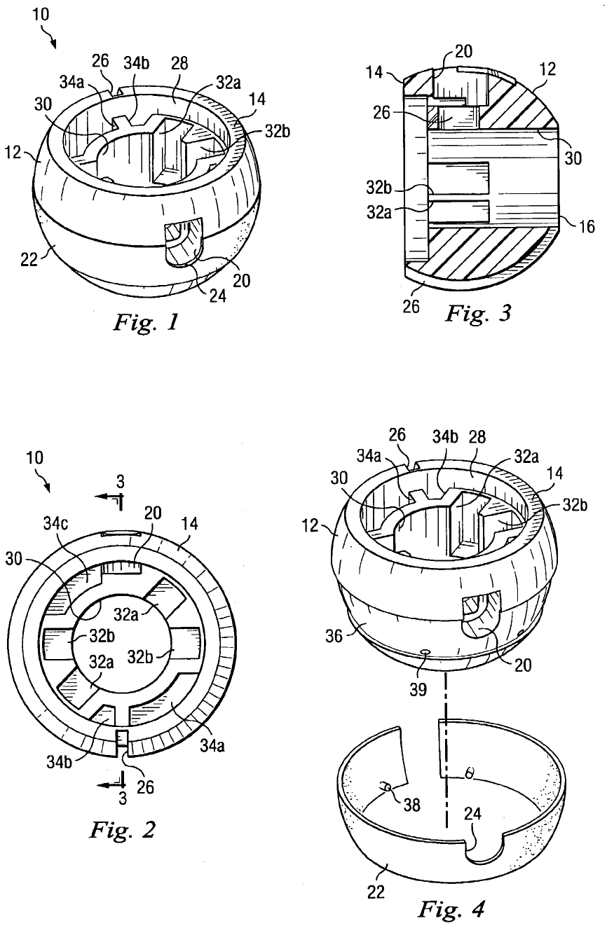

Referring to FIGS. 1-3, a fan ball according to one embodiment of the present invention is referred to generally by the reference numeral 10. The fan ball 10 comprises an outer surface 12, a top edge 14, and a bottom edge 16 (FIG. 3).

As shown in FIG. 3, the outer surface 12 is generally curved, the diameter of the fan ball 10 increasing from the bottom edge 16 until reaching its maximum diameter at a point below the top edge 14. The curvature of the outer surface 12 corresponds to the shape of a conventional mounting bracket, as will be described with reference to FIG. 6. A bore 20 is formed radially through a portion of the fan ball 10 for reasons to be described with reference to FIG. 6.

A damping ring 22, which will be discussed in greater detail with reference to FIG. 4, is disposed on the fan ball 10 and extends partially circumferentially about the outer surface 12. The damping ring 22 may be formed of rubber, polyethylene, or any material having a damping ability, such materials being well known to those skilled in the art. A slot 24 may further be formed in the damping ring 22 to correspond with the bore 20 formed through the fan ball 10.

A channel 26 is formed along the outer surface 12, extending between the top edge 14 and the bottom edge 16 for reasons to be described with reference to FIG. 6.

Turning now to the interior of the fan ball 10, a first interior bore 28 is disposed in the fan ball. A second interior bore 30 is disposed longitudinally through the fan ball 10 for receiving a conventional down rod assembly, as will be described with reference to FIG. 6. A plurality of transverse slots 32a-b are disposed between the first interior bore 28 and the second interior bore 30. A plurality of recesses 34a-c may further be formed in the fan ball 10 to reduce the materials necessary to form the fan ball.

Referring to FIG. 4, the damping ring 22 is retained in a slot 36. It is understood that the slot 36 may be formed in a variety of shapes so long as it is adapted to receive the damping ring 22.

In one embodiment, the damping ring 22 may comprise a plurality of posts 38 for engaging a plurality of corresponding receptacles 39 formed in the slot 36 of the fan ball 10. Thus, the damping ring 22 may be snap-fit onto the fan ball 10 by fitting the posts 38 to the corresponding receptacles 39.

Alternatively, the damping ring 22 may be injection molded into the slot 36 and the receptacles 39.

It can be appreciated that the damping ring 22 may be further secured into the slot 36 with any conventional adhesive. If adhesive is used, the posts 38 and the corresponding receptacles 39 may not be present.

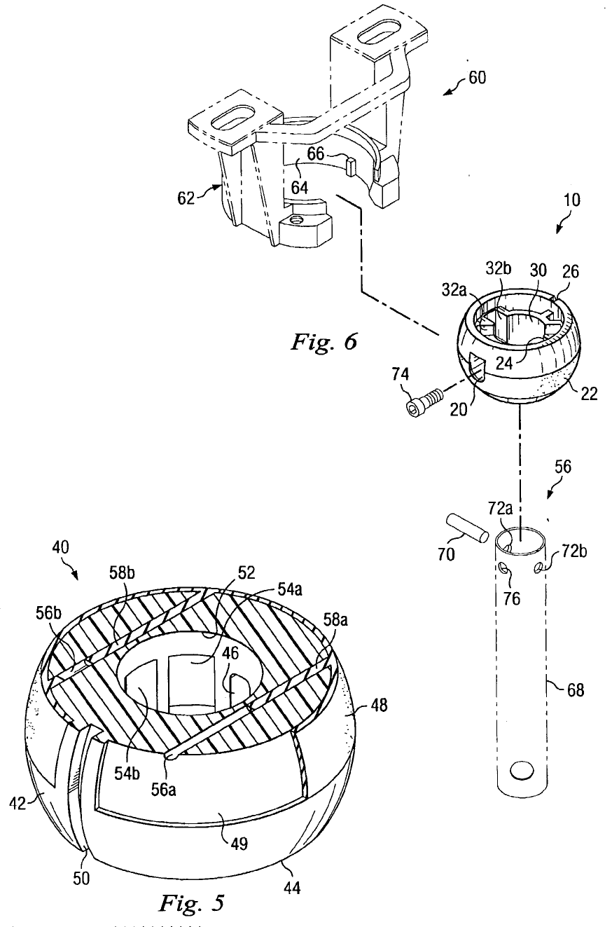

Referring to FIG. 5, in an alternative embodiment, a fan ball 40 comprises an outer surface 42 and a top edge 44.

As with the previously described embodiment shown in FIGS. 1-4, the outer surface 42 is generally curved for corresponding to the shape of a conventional mounting bracket, as will be described with reference to FIG. 6. A bore 46 is formed radially through a portion of the fan ball 10 for reasons to be described with reference to FIG. 6.

A damping ring 48 is disposed on the fan ball 10 and extends partially circumferentially about the outer surface 42. The damping ring 48 may be formed of rubber, polyethylene, or any material having a damping ability, such materials being well known to those skilled in the art.

The damping ring 48 is retained in a slot 49. It is understood that the slot 49 may be formed in a variety of shapes so long as it is adapted to receive the damping ring 48.

A channel 50 is formed along the outer surface 12, extending from the top edge 44 for reasons to be described with reference to FIG. 6.

Turning now to the interior of the fan ball 40, an interior bore 52 is disposed longitudinally through the fan ball for receiving a conventional down rod assembly, as will be described with reference to FIG. 6. A plurality of transverse slots 54a-b are disposed in the fan ball 40.

A pair of bores 56a-b are formed through the fan ball 40 for receiving a portion of the damping ring 48. The damping ring 48 may be injection molded, thus extruding a pair of connector portions 58a-b of the damping ring through the corresponding bores 56a-b.

In operation, and referring to FIG. 6, either of the previously described embodiments may be used as part of a ceiling fan mounting assembly 60. For sake of clarity, the operation is described with reference to the fan ball 10. A conventional mounting bracket 62 (illustrated in phantom) is conventionally attached to a fixed surface (not depicted). The mounting bracket 60 comprises a seat 64 adapted to receive the fan ball 10 to form a ball and socket type interaction. It is understood that the fan ball 10 may pivot within the seat 64. In one embodiment, a tab 66 extends from the seat 64 to engage the channel 26 formed in the fan ball 10, thereby allowing the fan ball 10 to pivot only in an arc defined by the plane of the tab.

Before insertion into the mounting bracket 62, the fan ball 10 is attached to a conventional down rod 68 (illustrated in phantom). It is understood that the down rod 68 is coupled to a conventional ceiling fan (not depicted).

The upper portion of the down rod 68 may be inserted into the fan ball 10 via the bore 30. A hanging pin 70 is then inserted radially through a pair of corresponding bores 72a-b disposed through the down rod 68. The fan ball 10 is then moved longitudinally toward the hanging pin 70 so that the hanging pin engages either of the slots 32a-b, thereby preventing the hanging pin from exiting the down rod 68 and evenly distributing the weight of the down rod and ceiling fan across the fan ball.

A connector 74, such as a screw, rod, or the like, can then be inserted through the bore 20 of the fan ball 10 to engage the down rod 68 and prevent longitudinal movement of the down rod with respect to the fan ball. In an alternative embodiment, the down rod 68 may have a radial bore 76 to correspond with the bore 20, the connector 74 passing through both bores.

The fan ball 10, now attached to the down rod 68 and the ceiling fan, is then inserted into the mounting bracket 62, the outer surface 12 engaging the seat 64. Once the ceiling fan (not depicted) is thus mounted, the damping ring 22 prevents the fan ball 10 from mechanically transferring any appreciable degree of vibration from the environment to the fan, thereby preventing undesirable noise.

While the invention has been particularly shown and described with reference to embodiments thereof, it will be understood by those skilled in the art that various changes in form and detail may be made therein without departing from the spirit and scope of the invention. It is also understood that all spatial references, such as “top,” “bottom,” “upper,” “lower,” “inner,” “outer,” “radially,” and “longitudinally” are for illustrative purposes only and can be varied within the scope of the invention. Therefore, the claims should be interpreted in a broad manner, consistent with the present invention.

What is claimed is:

1. A fan ball, comprising:
means for damping noise.

2. The fan ball of claim 1 wherein the means for damping noise is a damping ring.

3. The fan ball of claim 2 wherein the damping ring is a material having a damping ability.

4. The fan ball of claim 2 wherein the damping ring is rubber or polyethylene.

5. The fan ball of claim 2 wherein the damping ring comprises a plurality of posts for fitting to a plurality of receptacles formed in the fan ball.

6. The fan ball of claim 2 wherein the damping ring is formed integrally with the fan ball.

7. The fan ball of claim 2 further comprising a bore formed through the fan ball for receiving a portion of the damping ring.

8. The fan ball of claim 2 wherein the damping ring is secured to the fan ball via adhesive.

9. The fan ball of claim 2 wherein the damping ring is injection molded to the fan ball.

10. A ceiling fan mounting assembly including a mounting bracket, the assembly comprising:
a fan ball for engaging the mounting bracket, wherein the fan ball comprises means for damping noise.

11. The fan assembly of claim 10 wherein a down rod of the ceiling fan engages the fan ball.

12. The fan ball of claim 10 wherein the means for damping noise is a damping ring.

13. The fan ball of claim 12 wherein the damping ring is a material having a damping ability.

14. The fan ball of claim 12 wherein the damping ring is rubber or polyethylene.

15. The fan ball of claim 12 wherein the damping ring comprises a plurality of posts for fitting to a plurality of receptacles formed in the fan ball.

16. The fan ball of claim 12 wherein the damping ring is formed integrally with the fan ball.

17. The fan ball of claim 12 further comprising a bore formed through the fan ball for receiving a portion of the damping ring.

18. The fan ball of claim 12 wherein the damping ring is secured to the fan ball via adhesive.

19. The fan ball of claim 12 wherein the damping ring is injection molded to the fan ball.
